(19) United States
(12) Patent Application Publication
(10) Pub. No.: US 2022/0396014 A1
(43) Pub. Date: Dec. 15, 2022

(54) REFRIGERATOR FOAMING JIG AND FOAMING METHOD USING SAME

(71) Applicant: WINIA ELECTRONICS CO., LTD., Gwangju (KR)

(72) Inventors: Chang-Min KIM, Gwangju (KR); Sung-Ik CHANG, Gwangju (KR)

(73) Assignee: WINIA ELECTRONICS CO., LTD., Gwangju (KR)

(21) Appl. No.: 17/624,103

(22) PCT Filed: Jan. 7, 2021
(86) PCT No.: PCT/KR2021/000204

§ 371 Date: Dec. 30, 2021

(30) Foreign Application Priority Data
Jan. 8, 2020 (KR) 10-2020-0002788

(51) Int. Cl. B29C 44/58; B29C 44/02; F25D 23/06

(52) U.S. Cl. CPC B29C 44/583; B29C 44/02; F25D 23/064; B29L 2031/7622

(57) ABSTRACT

The present invention relates to a refrigerator foaming jig, and particularly, to a refrigerator foaming jig and a foaming method using same, the refrigerator foaming jig including: a refrigerator outer case in which a space part, into which a heat insulating material is injected, and a refrigerating compartment, and a freezer compartment are formed; and an ice-making compartment case which is installed inside the outer case and inside which an insulating material accommodation space communicating with the space part is formed. The refrigerator foaming jig comprises: a front jig coupled to an inner case; and a variable jig inserted into the partition part, wherein the variable jig expands toward the space part and the insulating material accommodation space or contracts inward so that the distance to the partition part is adjusted. According to the above configuration, the refrigerating compartment, the freezing compartment, and the ice-making compartment are simultaneously formed as independent spaces.

### TECHNICAL FIELD

The present disclosure relates to a refrigerator foaming jig and a foaming method using the same, and more particularly to a foaming jig for a refrigerator including a refrigerator compartment, a freezer compartment, and an ice making compartment and a foaming method using the same.

### BACKGROUND ART

In general, a refrigerator is a home appliance for storing food in a refrigerated or frozen state in a storage compartment opened and closed by a door. The refrigerator may generally include a refrigerator compartment for storing food in a refrigerated state at a low temperature and a freezer compartment for freezing and storing food in a frozen state.

The refrigerator may additionally include an ice making compartment that produces and stores ice for the convenience of a user. The refrigerator including the ice making compartment has a technology disclosed in Korean Patent No. 10-0674573 (Patent Document 1), by way of example.

Refrigerators that have been recently released have a tendency to provide a refrigerator compartment, that is used relatively more frequently than a freezer compartment, at an upper part of a main body and to provide the freezer compartment, that is used relatively less than the refrigerator compartment, at a lower part of the main body. In particular, French door refrigerators, in which a refrigerator compartment is opened and closed by two pivot doors that are respectively hinged and coupled to the left and right sides of a main body and are arranged side by side from left to right, and a freezer compartment is opened and closed by a drawer door slidably installed, have been recently in the spotlight.

In the refrigerator, a thermal insulation material is provided to the main body and an ice making compartment wall forming the ice making compartment. A related art related to this is disclosed in Korean Patent No. 10-1513876 (Patent Document 2).

A related art refrigerator includes a main body, a storage compartment provided inside the main body, an ice making compartment provided inside the main body to be partitioned from the storage compartment, and an ice maker provided inside the ice making compartment to produce ice. The ice making compartment is partitioned from a refrigerator compartment by an ice making compartment case. The main body includes a thermal insulation material foamed in a space between an outer case and an inner case. The ice making compartment case includes a thermal insulation material foamed in a thermal insulation material accommodation space.

In the related art refrigerator, an ice making box surrounded by a separate thermal insulation material was installed in the refrigerator main body after the foaming in the refrigerator compartment and a freezer compartment to form the ice making compartment. However, when the refrigerator compartment and the ice making box are not completely coupled, there is a problem in that a cold air leaks.

### PRIOR ART DOCUMENT

(Patent Document 1) Korean Patent No. 10-0674573 (2004 Mar. 26)

(Patent Document 2) Korean Patent No. 10-1513876 (2012 Jan. 6)

### DISCLOSURE

### Technical Problem

An object of the present disclosure is to address the above-described and other problems. Another object of the present disclosure is to provide a refrigerator foaming jig and a foaming method using the refrigerator foaming jig for simultaneously forming a refrigerator compartment, a freezer compartment, and an ice making compartment as individual spaces.

Another object of the present disclosure is to provide a refrigerator foaming jig and a foaming method using the same in which a shape of an ice making compartment is not deformed in a foaming process.

Another object of the present disclosure is to provide a refrigerator foaming jig and a foaming method using the same in which an evaporator case is supported on the foaming jig and the foaming can be stably performed.

Another object of the present disclosure is to provide a refrigerator foaming jig and a foaming method using the same in which the foaming jig and an ice making compartment case can be easily coupled.

### Technical Solution

In order to achieve the above-described and other objects, in one aspect of the present disclosure, there is provided a refrigerator foaming jig comprising a front jig inserted into a space portion into which a thermal insulation material is injected, and a refrigerator exterior case including a refrigerator compartment and a freezer compartment; and a variable jig installed inside the refrigerator exterior case, the variable jig being inserted into an ice making compartment case in which a thermal insulation material accommodating space communicating with the space portion is formed, wherein the variable jig is able to expand and contract inside the ice making compartment case and selectively supports an inner surface of the ice making compartment case.

The refrigerator foaming jig further comprises a rear fixing jig coupled to a rear side of the refrigerator exterior case; and a driver supported on the rear fixing jig and interlocked with the expanded variable jig.

An evaporator case is installed between the ice making compartment case and the rear fixing jig, and a protrusion formed on the rear fixing jig is inserted into the evaporator case.

The thermal insulation material accommodating space of the ice making compartment case is surrounded by the refrigerator compartment, and a remaining portion excluding the thermal insulation material accommodating space from the ice making compartment case is surrounded by the space portion. The ice making compartment as a separate independent space is formed inside the ice making compartment case.

The refrigerator compartment and the ice making compartment are simultaneously formed as an independent space by a foaming.

The freezer compartment is formed as an independent space at the same time as the refrigerator compartment and the ice making compartment by the foaming.

In another aspect of the present disclosure, there is provided a foaming method using a refrigerator foaming jig comprising coupling an ice making compartment case having a thermal insulation material accommodating space to an inside of an inner case including a refrigerator compartment and a freezer compartment; coupling an evaporator case to a rear of the inner case to be connected to the ice making compartment case; coupling an outer case to an outside of the inner case so that a space portion communicating with the thermal insulation material accommodating space is formed; inserting a front jig into the inner case and inserting a variable jig into the ice making compartment case; expanding the variable jig toward the space portion and the thermal insulation material accommodating space to support an inner surface of the ice making compartment case; and foaming a thermal insulation material in the space portion and the thermal insulation material accommodating space to simultaneously form the refrigerator compartment, the freezer compartment, and an ice making compartment.

Inserting the variable jig into the ice making compartment case is a step in which the variable jig of a contracted state does not support the inner surface of the ice making compartment case.

### Advantageous Effects

A refrigerator foaming jig and a foaming method using the same according to the present disclosure have the following effects.

According to a refrigerator foaming jig and a foaming method using the same according to an embodiment of the present disclosure, since a thermal insulation material is simultaneously foamed in a space portion and a thermal insulation material accommodating space of an inner case, a refrigerator compartment, a freezer compartment, and an ice making compartment can be simultaneously formed as an independent space.

According to a refrigerator foaming jig and a foaming method using the same according to an embodiment of the present disclosure, since a variable jig is in close contact with and supports an ice making compartment case, a shape of an ice making compartment can be prevented from being deformed by a foaming pressure in a foaming process.

According to a refrigerator foaming jig and a foaming method using the same according to an embodiment of the present disclosure, since an evaporator case is supported by a rear fixing jig and does not move, a stable foaming can be performed.

According to a refrigerator foaming jig and a foaming method using the same according to an embodiment of the present disclosure, since a variable jig can be contracted, it can be easily to insert the variable jig into an ice making compartment.

### DESCRIPTION OF DRAWINGS

FIG. 1 is a perspective view illustrating that a double door of a refrigerator manufactured according to an embodiment of the present disclosure is opened.

FIG. 2 is an enlarged view illustrating a main part of a refrigerator illustrated in FIG. 1.

FIG. 3 is an exploded perspective view of an ice making compartment case illustrated in FIG. 2.

FIG. 4 is a coupling perspective view of an ice making compartment case illustrated in FIG. 3.

FIG. 5 is a schematic perspective view of a front jig according to an embodiment of the present disclosure.

FIG. 6 is a side view illustrating that an ice making compartment case is coupled to a front jig illustrated in FIG. 5.

FIG. 7 is a schematic perspective view of a rear fixing jig according to an embodiment of the present disclosure.

FIG. 8 is a side view illustrating an integral foaming process using a refrigerator foaming jig according to an embodiment of the present disclosure.

FIG. 9 is a front view illustrating an integral foaming process using a refrigerator foaming jig according to an embodiment of the present disclosure.

### MODE FOR INVENTION

In embodiments of the present disclosure to be described below, reference for the same structure and components as those of a related art is made to the related art, and a detailed description thereof is omitted.

The technical terms disclosed herein are used to merely refer to a specific embodiment and does not intend to limit the present disclosure. A singular expression used in embodiments can include a plural expression as long as it does not have an apparently different meaning in context. In the present disclosure, terms “include” and “comprise” should be understood to be intended to designate that illustrated features, areas, numbers, steps, operations, components, parts and/or combinations thereof are present and not to preclude the existence of one or more different features, areas, numbers, steps, operations, components, parts and/or combinations thereof, or the possibility of the addition thereof.

When any component is described as “being connected” or “being coupled” to other component, this should be understood to mean that another component may exist between them, although any component may be directly connected or coupled to the other component.

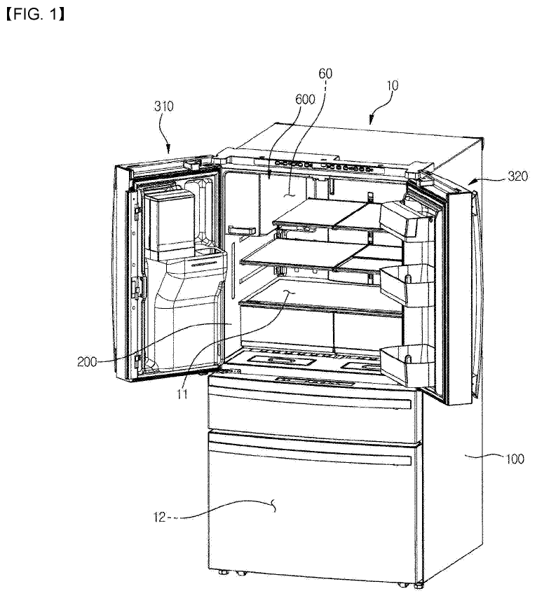

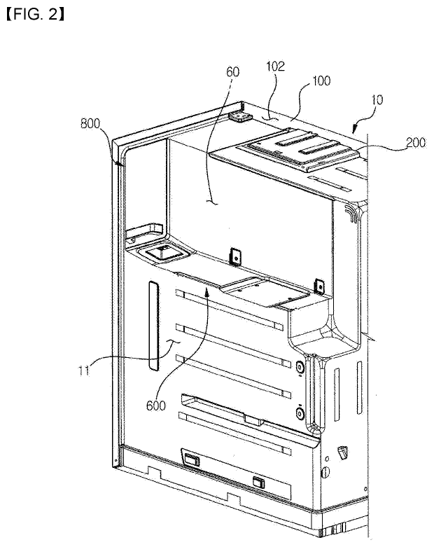

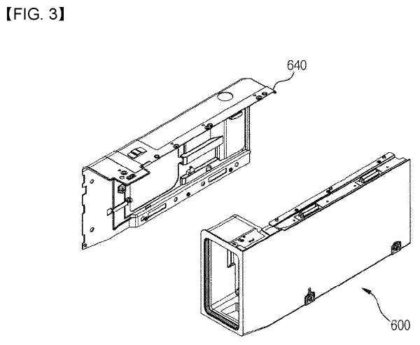

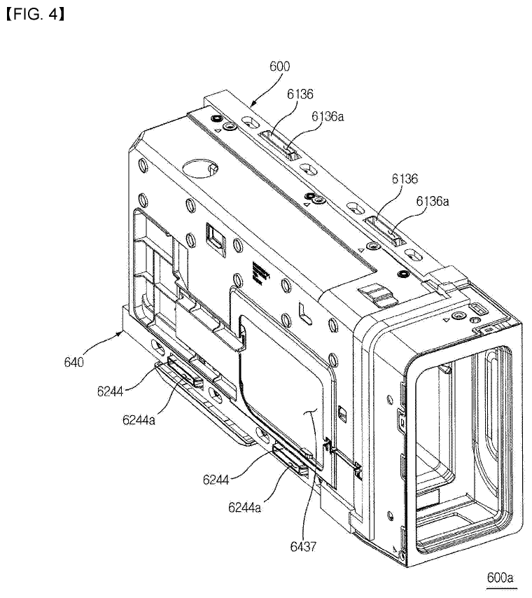

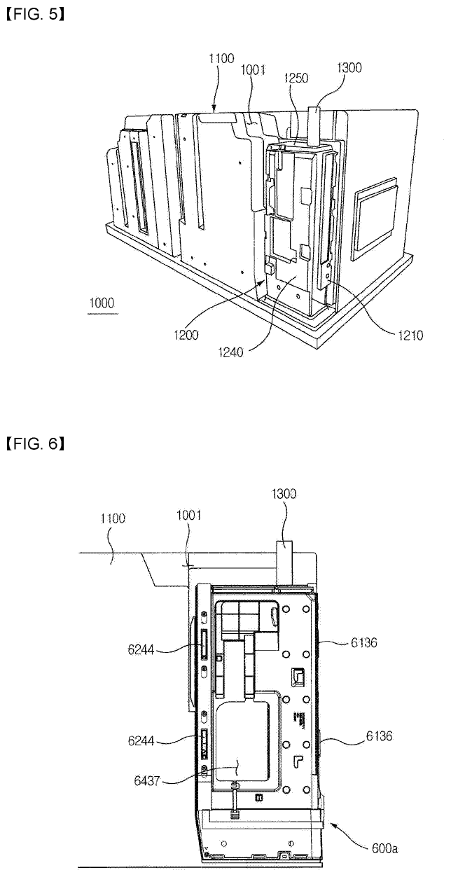

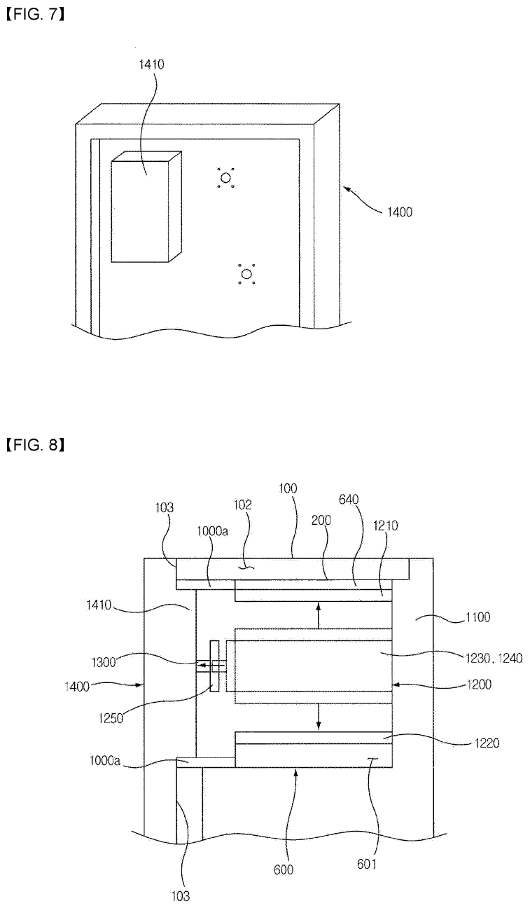

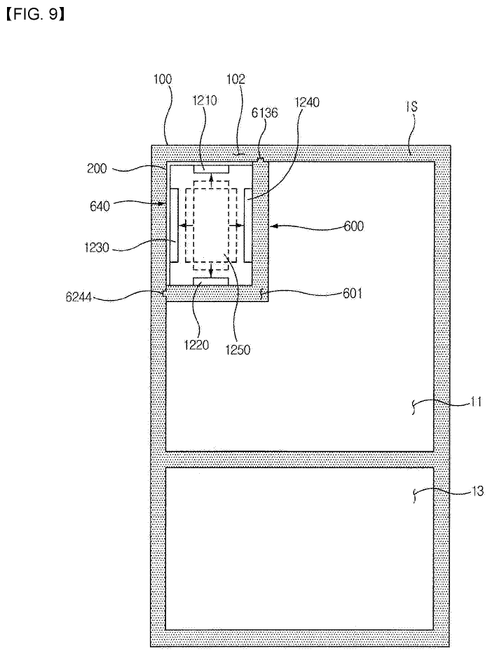

FIG. 1 is a perspective view illustrating that a double door of a refrigerator manufactured according to an embodiment of the present disclosure is opened. FIG. 2 is an enlarged view illustrating an outer case 100, an inner case 200, and an ice making compartment 60 that are main parts of the refrigerator illustrated in FIG. 1. FIG. 3 is an exploded perspective view of an ice making compartment case 600a coupled to the inner case 200 for forming the ice making compartment 60 illustrated in FIG. 2. FIG. 4 is a coupling perspective view of the ice making compartment case 600a illustrated in FIG. 3. FIG. 5 is a schematic perspective view of a front jig 1100 according to an embodiment of the present disclosure. FIG. 6 is a side view illustrating that the ice making compartment case 600a is coupled to the front jig 1100 illustrated in FIG. 5. FIG. 7 is a schematic perspective view of a rear fixing jig 1400 according to an embodiment of the present disclosure. FIG. 8 is a side view illustrating an integral foaming process using a refrigerator foaming jig 1000 according to an embodiment of the present disclosure. FIG. 9 is a front view illustrating an integral foaming process using the refrigerator foaming jig 1000 according to an embodiment of the present disclosure.

Referring to FIGS. 8 and 9, a variable jig 1200 is illustrated by a dotted line when it is in a contracted state, and the variable jig 1200 is illustrated by a solid line when it is in an expanded state.

As illustrated in FIG. 1, in a refrigerator applied to an embodiment of the present disclosure, a main body 10 may be configured to form an appearance of the refrigerator according to an embodiment of the present disclosure and may be formed in a rectangular parallelepiped box shape. The main body 10 may include the outer case 100, the inner case 200, a refrigerator compartment 11 provided at an upper part of the inner case 200, a freezer compartment 12 provided at a lower part of the inner case 200 to be disposed below the refrigerator compartment 11, the ice making compartment 60 formed as an independent space, and double door hinged type refrigerator compartment doors 310 and 320.

The outer case 100 and the inner case 200 may be substantially formed in a rectangular parallelepiped box shape.

The inner case 200 may be coupled to the outer case 100 by being accommodated and assembled in an inner space of the outer case 100. The inner case 200 may be coupled to the outer case 100 while providing a space portion 102 between the outer case 100 and the inner case 200 so that various wires can be accommodated and a thermal insulation material IS to be described later can be injected and foamed.

The inner case 200 has an opened front and may include the refrigerator compartment 11 and the freezer compartment 12.

A partition portion 600 provided as a separate component may be assembled at a corner of an upper side of the inner case 200.

The inner case 200 may include an evaporator case 1000a provided before being assembled with the partition portion 600 and the outer case 100.

Unlike the embodiment of the present disclosure, the inner case 200 and the partition portion 600 may be integrally formed through an injection.

The partition portion 600 may be a wall that serves as a right thermal insulation wall and a lower thermal insulation wall for forming the ice making compartment 60.

An embodiment of the present disclosure may include a front jig 1100 inserted into the inner case 200 among refrigerator exterior cases 100 and 200; and a variable jig 1200 that is installed in the exterior cases 100 and 200 and is inserted into the ice making compartment case 600a formed in a thermal insulation material accommodating space 601 communicating with the space portion 102. The variable jig 1200 may be provided to be stretchable inside the ice making compartment case 600a and may selectively support an inner surface of the ice making compartment case 600a.

Specifically, the refrigerator exterior cases 100 and 200 may include the refrigerator outer case 100 and the refrigerator inner case 200 that is assembled with the outer case 100 to form the space portion 102, into which the thermal insulation material IS is injected, and is provided with the refrigerator compartment 11 and the freezer compartment 12.

The refrigerator foaming jig 1000 may be assembled with the ice making compartment case 600a that is installed inside the inner case 200 to form the ice making compartment 60.

The variable jig 1200 may be inserted into the ice making compartment case 600a.

Specifically, the variable jig 1200 may expand or inwardly contract in a direction of the space portion 102 and a direction of the thermal insulation material accommodating space 601 so that a distance between the variable jig 1200 and the ice making compartment case 600a is adjusted.

An embodiment of the present disclosure having the above-described configuration can prevent a deformation of the ice making compartment case 600a, since the variable jig 1200 is in close contact with the ice making compartment case 600a and resists a foaming pressure when the foaming pressure is applied to the inner case 200 and the ice making compartment case 600a in an inward direction.

The variable jig 1200 may be inserted into the ice making compartment case 600a in a contracted state. Thus, the variable jig 1200 can be easily coupled to the ice making compartment case 600a.

An embodiment of the present disclosure may further include a rear plate case 103 that is coupled to the exterior cases 100 and 200 to form a rear exterior of the refrigerator; a rear fixing jig 1400 coupled to the rear side of the exterior cases 100 and 200, i.e., the rear side of the rear plate case 103; and a driver 1300 that is interlocked with the expanded variable jig 1200 and is supported by the rear fixing jig 1400.

The rear fixing jig 1400 may be coupled to the rear plate case 103 to cover the entire rear plate case 103.

As illustrated in FIG. 8, the evaporator case 1000a may be formed between the ice making compartment case 600a and the rear plate case 103, and a protrusion 1410 formed on the rear fixing jig 1400 may be inserted into a through hole formed in the evaporator case 1000a. Thus, since the evaporator case 1000a is also supported by the foaming jig 1000 and does not move, stable foaming can be performed.

The evaporator case 1000a may be positioned between the rear side of the ice making compartment case 600a and the rear plate case 103 to be accommodated in a depression of the inner case 200.

The evaporator case 1000a may accommodate a fan, an evaporator, and a thermal insulation cover in the order named from the front side.

The evaporator case 1000a has a pipe shape with a substantially rectangular cross-section in which the front and the rear are penetrated when viewed from the front.

The rear plate case 103 may include a hole in which the front and the rear are penetrated so that the inside of the evaporator case 1000a communicates with an external space.

The thermal insulation material accommodating space 601 of the ice making compartment case 600a may be surrounded by the refrigerator compartment 11 and the freezer compartment 12, and a remaining portion excluding the thermal insulation material accommodating space 601 from the ice making compartment case 600a may be surrounded by the space portion 102. Hence, the ice making compartment 60 as a separate independent space may be formed inside the ice making compartment case 600a.

The refrigerator compartment 11 and the ice making compartment 60 may be simultaneously formed as an independent space by foaming the thermal insulation material.

The freezer compartment 12 may be formed as an independent space at the same time as the refrigerator compartment 11 and the ice making compartment 60 by foaming the thermal insulation material.

Hence, when the thermal insulation material IS is foamed in the space portion 102 and the thermal insulation material accommodating space 601, the thermal insulation material IS may be disposed in all the upper, lower, left and right sides of the ice making compartment case 600a. Further, since a separate configuration is assembled to the front and rear sides of the ice making compartment case 600a, the ice making compartment 60 can be formed as an independent thermal insulation space.

In this instance, referring to FIG. 9, the right and lower sides of the ice making compartment case 600a are surrounded by the refrigerator compartment 11.

In addition, the left and upper sides of the ice making compartment case 600a are surrounded by the space portion 102. Specifically, the left and upper sides of the ice making compartment case 600a contact an inside case. This is described in detail later.

Specifically, the ice making compartment case 600a may include the ice making compartment case 600a forming the thermal insulation material accommodating space 601 forming the lower, lower, left and right sides, and an installation wall 640 that is coupled to a partition 600 to be described later and is installed in the inner case 200.

The installation wall 640 may be coupled to an inner surface of an upper wall and an inner surface of a left wall of the inner case 200 while being coupled to the partition portion 600.

Referring to FIG. 9, when the refrigerator is viewed from the front, the partition portion 600 may have a shape in which ‘¬’-shaped is rotated 90 degrees clockwise, and the installation wall 640 may have a shape in which ‘¬’-shaped is rotated 90 degrees clockwise.

The installation wall 640 may correspond to the upper side and the left side of the ice making compartment case 600a, and the partition portion 600 may correspond to the lower side and the right side of the ice making compartment case 600a. Thus, when viewed from the front, the ice making compartment case 600a has a pipe shape with a substantially rectangular cross section in which the front and the rear are penetrated.

Referring to FIGS. 8 and 9, a thickness of the partition portion 600 in which the thermal insulation material IS is accommodated is greater than a thickness of the installation wall 640.

A through hole may be formed in the partition portion 600 so that the thermal insulation material accommodating space 601 and the space portion 102 communicate with each other.

More specifically, referring to FIGS. 4 and 9, a first protrusion 6136 having a first through hole 6136a may be formed on the upper surface of the partition portion 600, and a second protrusion 6244 having a second through hole 6244a may be formed on the left side of the partition portion 600.

The installation wall 640 is configured to install a harness connected to the components related to an operation of an ice maker in an installation hole 6437, guide an ice storage bucket to be taken in and out, and install the ice maker.

Hence, referring to FIG. 9, the upper, lower, left, and right sides, i.e., all the sides of the ice making compartment 60 are surrounded by the thermal insulation material IS foamed in the space portion 102 and the thermal insulation material IS foamed in the thermal insulation material accommodating space 601, and thus the ice making compartment 60 may be formed as a separate thermal insulation space from the refrigerator compartment 11.

The variable jig 1200 may include an upper jig 1210 and a lower jig 1220 facing each other, a left jig 1230 and a right jig 1240 facing each other, and a rear jig 1250 connected to the driver 1300.

In the present embodiment, the driver 1300 may have a rod shape.

The driver 1300 may be interlocked with the variable jig 1200. That is, when the driver 1300 moves forward, the variable jig 1200 may be in an expanded state, and when the driver 1300 moves rearward, the variable jig 1200 may be in a contracted state.

When the driver 1300 moves forward as shown by the solid line from a position shown by the dotted line of FIG. 8, the variable jig 1200 may expand as illustrated in FIGS. 8 and 9. More specifically, the upper jig 1210 and the lower jig 1220 may move away from each other as the upper jig 1210 moves upward and the lower jig 1220 moves downward, and the left jig 1230 and the right jig 1240 may move away from each other as the left jig 1230 moves to the left and the right jig 1240 moves to the right.

As a result, referring to FIG. 9, when the refrigerator is viewed from the front, the upper jig 1210 may be in close contact with the upper inner surface of the installation wall 640, the lower jig 1220 may be in close contact with the lower inner surface of the partition portion 600, the left jig 1230 may be in close contact with the left inner surface of the installation wall 640, and the right jig 1240 may be in close contact with the right inner surface of the partition portion 600.

Referring to FIG. 8, since the driver 1300 moving forward is supported on the protrusion 1410 of the rear fixing jig 1400, the driver 1300 may serve to prevent the variable jig 1200 from shaking. Thus, when the thermal insulation material IS is foamed, even if a foaming pressure is applied to the ice making compartment case 600a in the inward direction, an original shape of the ice making compartment case 600a can be maintained since the ice making compartment case 600a is supported by the variable jig 1200. Therefore, a result of foaming the thermal insulation material IS is good.

The rear fixing jig 1400 may be formed in a substantially plate shape.

The protrusion 1410 may be formed at an arbitrary position of the rear fixing jig 1400. The arbitrary position may be a position at which the protrusion 1410 is inserted into the evaporator case 1000a when the rear fixing jig 1400 is coupled to the rear plate case 103. Therefore, when the thermal insulation material IS is foamed, since the rear plate case 103 is firmly coupled to the evaporator case 1000a, the foaming result is good.

====Foaming Method Using Refrigerator Foaming Jig====

A foaming method using a refrigerator foaming jig 1000 according to an embodiment of the present disclosure is described below.

A foaming method using the refrigerator foaming jig 1000 according to an embodiment of the present disclosure may comprise a step of coupling an ice making compartment case 600a having a thermal insulation material accommodating space 601 to an inside of an inner case 200 including a refrigerator compartment 11 and a freezer compartment 12; a step of coupling an evaporator case 1000a to a rear of the inner case 200 to be connected to the ice making compartment case 600a; a step of coupling an outer case 100 to an outside of the inner case 200 so that a space portion 102 communicating with the thermal insulation material accommodating space 601 is formed; a step of inserting a front jig 1100 into the inner case 200 and inserting a variable jig 1200 into the ice making compartment case 600a; a step of expanding the variable jig 1200 toward the space portion 102 and the thermal insulation material accommodating space 601 to support an inner surface of the ice making compartment case 600a; and a step of foaming a thermal insulation material IS in the space portion 102 and the thermal insulation material accommodating space 601 to simultaneously form the refrigerator compartment 11 and an ice making compartment 60.

The step of forming the ice making compartment 60 may be a step of simultaneously forming the refrigerator compartment 11 and the ice making compartment 60 as an independent space by an integral foaming.

The step of forming the ice making compartment 60 may further comprise a step of forming the freezer compartment 12 as an independent space at the same as the refrigerator compartment 11 and the ice making compartment 60 by foaming the thermal insulation material.

The step of inserting the variable jig 1200 into the ice making compartment case 600a may be a step in which the variable jig 1200 of a contracted state does not support the inner surface of the ice making compartment case 600a. Thus, the variable jig 1200 can be easily inserted into the ice making compartment case 600a.

The front jig 1100 may have a shape corresponding to a shape of a portion excluding the ice making compartment case 600a from an inner shape of the inner case 200.

Referring to FIG. 5, the front jig 1100 may have a depression 1001 at a rear side of the variable jig 1200. Referring to FIG. 6, when the variable jig 1200 is inserted into the ice making compartment case 600a, a space capable of accommodating the evaporator case 1000a may be formed in the depression 1001 of the front jig 1100.

The foaming method using the refrigerator foaming jig 1000 is described in more detail below.

First, the inner case 200 including the refrigerator compartment 11 and the freezer compartment 12 may be provided.

Next, referring to FIGS. 1, 2, and 9, an ice maker case having the thermal insulation material accommodating space 601 may be installed at an edge where the upper side and the left side of the inner surface of the inner case 200 meet.

Next, the evaporator case 1000a may be formed at the rear of the inner case 200 so that the evaporator case 1000a is positioned at the rear of the ice maker case.

Next, the outer case 100 may be coupled to the inner case 200 so that the space portion 102, in which the thermal insulation material IS is foamed, is formed outside the inner case 200. Hence, the first through hole 6136a and the second through hole 6244a of the ice making compartment case 600a may communicate with the space portion 102.

Next, the front jig 1100 may be injected into the refrigerator compartment 11 and the freezer compartment 12, and the variable jig 1200 of a contracted state may be injected into the ice making compartment case 600a.

Next, when the coupling between the foaming jig 1000 and the inner case 200 and the ice making compartment case 600a is completed, the driver 1300 may move forward and the variable jig 1200 may expand. Hence, the variable jig 1200 may be in close contact with the inner surface of the ice making compartment case 600a, and the driver 1300 may be supported on the protrusion 1410 of the rear fixing jig 1400.

Next, referring to FIG. 9, the thermal insulation material IS may be inserted into the space portion 102 and the thermal insulation material accommodating space 601 that communicate with each other, and then may be integrally foamed. That is, the ice making compartment 60 can be formed as a separate thermal insulation space from the refrigerator compartment 11 and the freezer compartment 12 by the integral foaming at the same time.

The ice making compartment 60 may include an ice maker, an ice storage bucket, etc.

Although the embodiments have been described with reference to a number of illustrative embodiments thereof, numerous other modifications and embodiments may be devised by those skilled in the art that will fall within the scope of the principles of the present disclosure. In particular, various variations and modifications are possible in the component parts and/or arrangements of the subject combination arrangement within the scope of the disclosure, the drawings and the appended claims.

[Description of reference numerals]
** Description of main reference numerals **

```
  11: refrigerator compartment
  12: freezer compartment
  60: ice making compartment
  100: outer case
  102: space portion
  103: rear plate case
  200: inner case
  600: partition portion
  600a: ice making compartment case
  601: thermal insulation material accommodating space
  640: installation wall
1000: foaming jig
1000a: evaporator case
1001: depression
1100: front jig
1200: variable jig
1300: driver
1400: rear fixing jig
1410: protrusion
IS: thermal insulation material
```

1. A refrigerator foaming jig comprising:
a front jig inserted into a space portion into which a thermal insulation material is injected, and a refrigerator exterior case including a refrigerator compartment and a freezer compartment; and
a variable jig installed inside the refrigerator exterior case, the variable jig being inserted into an ice making compartment case in which a thermal insulation material accommodating space communicating with the space portion is formed,
wherein the variable jig is able to expand and contract inside the ice making compartment case and selectively supports an inner surface of the ice making compartment case.

2. The refrigerator foaming jig of claim 1, further comprising:
a rear fixing jig coupled to a rear side of the refrigerator exterior case; and
a driver supported on the rear fixing jig and interlocked with the expanded variable jig.

3. The refrigerator foaming jig of claim 2, wherein an evaporator case is installed between the ice making compartment case and the rear fixing jig, and
wherein a protrusion formed on the rear fixing jig is inserted into the evaporator case.

4. The refrigerator foaming jig of claim 1, wherein the thermal insulation material accommodating space of the ice making compartment case is surrounded by the refrigerator compartment, and a remaining portion excluding the thermal insulation material accommodating space from the ice making compartment case is surrounded by the space portion, and
wherein the ice making compartment as a separate independent space is formed inside the ice making compartment case.

5. The refrigerator foaming jig of claim 1, wherein the refrigerator compartment and the ice making compartment are simultaneously formed as an independent space by a foaming.

6. The refrigerator foaming jig of claim 5, wherein the freezer compartment is formed as an independent space at the same time as the refrigerator compartment and the ice making compartment by the foaming.

7. A foaming method using a refrigerator foaming jig, the foaming method comprising:
coupling an ice making compartment case having a thermal insulation material accommodating space to an inside of an inner case including a refrigerator compartment and a freezer compartment;
coupling an evaporator case to a rear of the inner case to be connected to the ice making compartment case;
coupling an outer case to an outside of the inner case so that a space portion communicating with the thermal insulation material accommodating space is formed;
inserting a front jig into the inner case and inserting a variable jig into the ice making compartment case;
expanding the variable jig toward the space portion and the thermal insulation material accommodating space to support an inner surface of the ice making compartment case; and
foaming a thermal insulation material in the space portion and the thermal insulation material accommodating space to simultaneously form the refrigerator compartment, the freezer compartment, and an ice making compartment.

8. The foaming method of claim 7, wherein inserting the variable jig into the ice making compartment case is a step in which the variable jig of a contracted state does not support the inner surface of the ice making compartment case.

9. The refrigerator foaming jig of claim 2, wherein the refrigerator compartment and the ice making compartment are simultaneously formed as an independent space by a foaming.

10. The refrigerator foaming jig of claim 3, wherein the refrigerator compartment and the ice making compartment are simultaneously formed as an independent space by a foaming.

11. The refrigerator foaming jig of claim 4, wherein the refrigerator compartment and the ice making compartment are simultaneously formed as an independent space by a foaming.
